(19) United States
(12) Patent Application Publication
(10) Pub. No.: US 2004/0112135 A1
(43) Pub. Date: Jun. 17, 2004

(54) Star patterned accelerometer reed

(76) Inventor: Norberto P. Letrondo, North Bend, WA (US)

Correspondence Address: Black Lowe & Graham, PLLC, 816 Second Avenue, Seattle, WA, 98104, US

(21) Appl. No.: 10/394,920

(22) Filed: Mar. 24, 2003

Related U.S. Application Data
(63) Continuation-in-part of application No. 09/188,865, filed on Nov. 9, 1998, now abandoned.
Application No. 09/188,865 is a continuation-in-part of application No. 08/835,872, filed on Apr. 8, 1997, now Pat. No. 5,959,207.
Application No. 08/835,872 is a continuation of application No. 08/515,442, filed on Aug. 15, 1995, now abandoned.

(51) Int. Cl. G01P 15/13; G01P 15/125

(52) U.S. Cl. 73/514.17

(57) ABSTRACT

An arcuate reed for use with a capacitance type accelerometer proof mass. The reed includes grooves for improved gas damping and reduced latch-up without a reduction in damping effects.

This application is a Continuation in Part of U.S. patent application Ser. No. 09/188,865 filed Nov. 9, 1998 entitled “Star Patterned Accelerometer Reed” which is a Continuation in Part of U.S. patent application Ser. No. 08/835,872 filed Apr. 8, 1997 having the same title which is a continuation of Ser. No. 08/515,442 having the same title and filed Aug. 15, 1995.

### FIELD OF THE INVENTION

This invention relates generally to accelerometers and, more specifically, to force rebalance accelerometers.

### BACKGROUND OF THE INVENTION

Force rebalance accelerometers which include a proof mass suspended between one or more magnet assemblies are generally known in the art. Examples of such accelerometers are disclosed in U.S. Pat. Nos. 4,182,187; 4,250,757; 4,399,700; 4,400,979, 4,441,366; 4,555,944; 4,555,945; 4,592,234; 4,620,442; 4,697,455; 4,726,288; 4,932,258; 4,944,184; 5,024,089; 5,085,079; 5,090,243; 5,097,172; 5,111,694; 5,182,949; 5,203,210; 5,212,984; 5,220,831; and Re. 34,631 all of which are incorporated herein by reference.

Such force rebalance accelerometers normally include a proof mass having a reed or flapper formed from amorphous quartz, suspended by one or more flexures between stators having permanent magnets to enable the proof mass to defect in response to forces or accelerations along a sensitive axis, generally perpendicular to the plane of the proof mass. The proof mass also typically includes at least one torquer coil secured to the reed which functions as an electromagnet. At rest, the proof mass is normally suspended equidistantly between upper and lower excitation rings. Electrically conductive material forming pick-off capacitance plates, is disposed on opposing sides of the proof mass to form capacitive elements with the excitation rings. An acceleration or force applied along the sensitive axis causes the proof mass to deflect either upwardly or downwardly which causes the distance between the pick-off capacitance plates and the upper and lower excitation rings to vary. This change in the distance between the pick-off capacitance plates and the upper and lower excitation rings causes a change in the capacitance of the capacitive elements. The difference in the capacitances of the capacitive elements is thus representative of the displacement of the proof mass along the sensitive axis. This displacement signal is applied to a servo system that includes the torquer coils which function, in combination with a current applied to the torquer coils and the permanent magnets, to return the proof mass to its null or at-rest position. The magnitude of the drive currents applied to the torquer coils, in turn, is representative of the acceleration of force along the sensitive axis.

One problem encountered in this type of accelerometer results from the use of a gas, usually a mixture of neutral gases such as helium and nitrogen, utilized to fill the accelerometer to provide gas damping for the proof mass. Under extreme acceleration conditions, it has been found that the gas damping can result in an overshoot condition when the extreme acceleration condition is removed.

In addition, it has been discovered that in certain power off situations, the reed, which has a highly polished surface will have a tendency to stick or latch up to the highly polished surface of the stator thereby increasing turn on times for the accelerometer. One approach to solving this problem is described in U.S. Pat. No. 4,825,335 wherein a rectangular moveable capacitor plate, which is suspended on each side by fingers, is provided with a number of air passages extending through the plate along with grooves in the plate leading up to the air passages to facilitate the flow of air. However, etching holes in the flapper of the above described accelerometer is not a practical solution to this problem.

In currently known low frequency force rebalance accelerometers, the component of damping of a pendulum suspended between two capacitor plates was essentially described by theoretical flat plate dumping according to the equation:

damping coefficient=βA²/h³ (1)

where: A is the area of the plate,

h is the distance between the pendulum and the relevant capacitor plate; and

β is a constant dependent upon the shape of the area.

This theoretical flat plate damping equation applied when three conditions pertained. First, when the distance, h, was small relative to the pendulum dimensions. For example, when the ratio of the distance, h, to the pendulum diameter was on the order of 1/1000. Second, when the displacements of the pendulum were small compared with the distance, h, i.e., when the accelerometer was in servo. Third, when the accelerometer responded to low frequency input, for example, a vibration or shock environment below 10 KHz.

### SUMMARY OF THE INVENTION

It is therefore an object of the invention to provide for improved gas damping and reduced lock up in an accelerometer having a proof mass that includes an arcuate reed suspended by hinges for rotation between two stator members.

It is a further object of the invention to provide an arcuate reed for use with a proof mass of an accelerometer where the reed includes a number of radially extending grooves.

Another object of the invention is to provide an arcuate reed for use with a proof mass, which is suspended by a pair of flexure hinges between a pair of stators, where the reed includes radially extending grooves etched on both sides and located at approximately 45 degree intervals on the side away from the hinges. In a reed approximately 0.030 inches thick, the grooves can be 0.020 inches wide and 0.0005 inches deep.

### BRIEF DESCRIPTION OF THE DRAWINGS

The preferred and alternative embodiments of the present invention are described in detail below with reference to the following drawings.

FIG. 1 is an exploded perspective view of a force rebalance accelerometer according to the invention;

FIG. 2 is a top view of a reed having grooves for use with the accelerometer of FIG. 1; and

FIG. 3 is a graph of damping coefficient according to the present invention.

### DETAILED DESCRIPTION OF THE PREFERRED EMBODIMENT

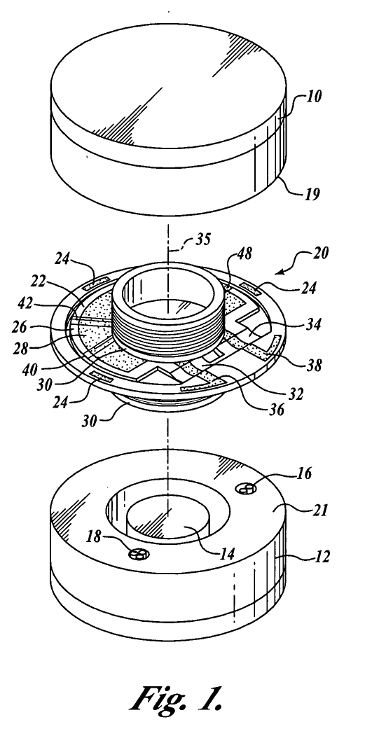

FIG. 1 illustrates in an exploded view form, an acceleration transducer of the type disclosed in detail in the aforementioned U.S. Pat. No. 4,250,757. In this embodiment, for descriptive purposes, the accelerometer includes an upper magnet or stator structure 10 and a lower magnet or stator structure 12. Included in each of the upper 10 and lower 12 stator structures are permanent magnets as illustrated by a magnet 14 shown in the lower stator structure 12. In addition, the lower stator structure includes support posts for electrical lead as illustrated at 16 and 18. Also shown in FIG. 1 is a movable element assembly in form of a proof mass assembly, generally indicated at 20. Included in the proof mass assembly is an outer annular support member or ring 22 which is supported between opposed planar surfaces 19 and 21 of the upper stator structure 10 and the lower stator structure 12 by pairs of spacer elements or mounting pads 24 on the member 22. The lower pad of each pair of mounting pads is not shown in the drawing. As shown in FIG. 1, the location of each pair of mounting pads 24 is spaced apart from each other around the support ring 22. Included in the proof mass assembly 20 is a movable flapper or reed 26 extending radially inward from the outer support ring 22. The reed 26 has an electrically conductive material, preferably gold and having an arcuate shape, that serves as a capacitive pick-off area or plate 28. The capacitive pick-off plates 28 on the upper and lower surfaces of the reed 26 cooperate with the opposed planar surfaces 19 and 21 of the upper and lower stator structures 10 and 12 to provide a capacitive pick-off system.

Mounted on each side of the reed 26 is a force restoring coil 30. As is well understood in the art, the force restoring or torquer coils 30 cooperate with the permanent magnets 14 to retain the reed 26 within a predetermined position with respect to the support ring 22.

The reed 26, including the force restoring coils 30, is connected to the support ring 22 by means of a pair of flexure elements 32 and 34. The flexure elements 32 and 34 permit the proof mass assembly 20 including the reed 26 and the coil 30 to move in a rotational pendulous manner with respect to the annular support ring 22. The reed 26 will move in response to forces along the sensitive axis 35 of the accelerometer. Also deposited on the support ring 22 and flexure elements 32 and 34 are thin film pick-off leads 36 and 38 which provide electrical connections to the capacitive pick-off plates 28 and the force restoring coils 30.

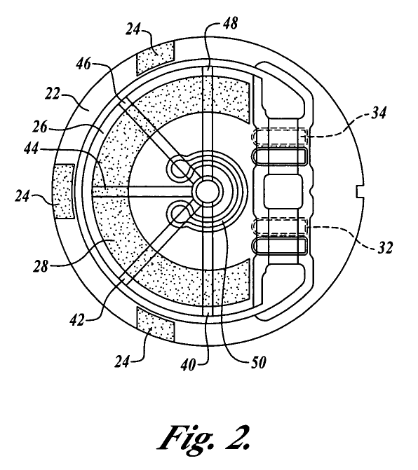

In order to increase damping efficiency and reduce lock-up, the reed 26, as shown in the top view of FIG. 2, is configured with a set of radially extending grooves 40-48 in the upper surface. The drawing of FIG. 2 omits the torquer coils 30 shown in. FIG. 1 and illustrates a cut out area 50 on the reed 26 which permits electrical connections to the torquer coils 30. In the preferred embodiment of the invention, the five grooves 40-48 are spaced at 45 degree intervals in a star pattern on the upper surface of the half of the reed 26, which is opposite the flexure elements 32 and 34. In one embodiment, corresponding grooves (not shown) are also etched in the lower surface of the reed. However, in another embodiment, the grooves are etched in only one of either the upper surface of the reed 26 or the lower surface of the reed 26, as desired for a particular application. The grooves 40-48 extend radially from the cut out area 50 to the edges of the reed 26. In the embodiment of the reed 26 shown in FIG. 2, the reed 26 is approximately 0.030 inches thick with a diameter of 0.642 inches and the grooves 40-48 etched into the reed 26 are approximately 0.020 inches wide with an approximate depth of 0.0005 inches which depth is less than the typical pick off gap of 0.00075 inches.

Grooves which are smaller than the gap between the pendulum and the capacitive pick-off plate 28 when the pendulum is positioned equidistant from each of the two capacitive pick-off plates 28 become significant when the pendulum approaches the capacitive pick-off plate 28 and the gap becomes smaller. Such a situation pertains when the accelerometer is no longer in servo but is operating beyond its design range, for example, when the input accelerometer is greater than the device input limits. When this situation pertains, the small grooves of the present invention significantly affect the component of damping described by theoretical flat plate damping. For example, when the pendulum is positioned near one of the two capacitive pick-off plates 28, the coefficient of flat damping is given by the equation:

damping=1/(h+d)³≃1/(2h)³ (2)

where: h is the distance between the capacitive pick-off plate 28 and the pendulum; and

d is the depth of the grooves.

Grooves which are smaller than the gap between the pendulum and the capacitive pick-off plate 28 when the pendulum is positioned equidistant from each of the two capacitive pick-off plates 28 do not significantly affect the component of damping due to frictional gas glow across the pendulum surface when the pendulum is positioned equidistant from each of the two capacitive pick-off plates 28, i.e., when the accelerometer is in servo. As the pendulum approaches the capacitive pick-off plate 28 and the gap becomes smaller, the grooves become significant avenues of escape for damping gas trapped between the pendulum and the capacitive pick-off plate 28. Thus, small grooves in the pendulum significantly reduce the component of damping due to frictional gas flow across the pendulum surface as the pendulum approaches the capacitive pick-off plate 28.

It will be appreciated that the present invention advantageously provides a damping coefficient with greatly reduced non-linearity as a function of proof mass position relative to the capacitive pick-off plates 28. Referring now to FIG. 3 and to equation (2), a graph 100 shows a plot of the relationship given in equation (1). The present invention improves the gas damping performance of the accelerometer by reducing the coefficient of damping at pendulum positions near the capacitive pick-off plate 28 where damping gas can cause overshoot in extreme acceleration conditions and smooth pendulum/capacitor surfaces can cause accelerometer lockup. By configuring the invention to delay or reduce only the rapid increase in the coefficient of damping as the pendulum approaches the capacitive pick-off plate 28, as predicted by the cubic function, while leaving the coefficient of damping unaffected at the nominal servo position, the present invention significantly flattens the curve over its entire range of operation. The resulting response of the coefficient of damping to pendulum position is substantially reduced non-linearity.

Non-linearity of the coefficient of damping curve is substantially reduced as follows. It will be appreciated that the groove features, with depth d significantly less than the servo-position gap h between the pendulum and capacitive pick-off plate 28, have little effect on the coefficient of damping at the servo position, as can be seen by the governing equation CD=k×1/(h+d)³, where k is a constant. Near the servo position, the coefficient of damping can be approximated as CD=k×1/(h)³. At pendulum positions near the capacitive pick-off plate 28, where h is small relative to d, the groove features become significant, and the coefficient of damping approaches CD=k×1(d)³.

FIG. 3 illustrates the effect of the groove configuration on the coefficient of damping over the accelerometer's range of operation. The coefficient of damping for the flat plate case varies with pendulum position by the inverse cube function CD=k×1/(h)³. By way of contrast, a deeply grooved plate, such as that taught in U.S. Pat. No. 5,350,189 also varies with the inverse cube function, but at a reduced level across the entire operating range, CD=k₂×1/(h)³, where k₂ is lower than k. Advantageously, a shallowly grooved plate, such as that of the present invention, varies by the inverse cube function, CD=k×1/(h+d)³, where the influence of d flattens the curve as the reed/plate gap becomes smaller and non-linearity of the curve becomes greatly reduced.

When the grooves formed in the pendulum are small compared with the distance h, the present invention does not significantly affect the assumption that the dependence of damping on the gap size or distance h, is described by theoretical flat plate damping or damping α1/h³. For example, when the pendulum is positioned equidistant from each of the two capacitive pick-off plates 28, i.e., when the accelerometer is in servo, the dependence of the damping coefficient on the distance h lies along a continuum ranging from 1/(h+d)³ to 1/h³ depending upon the exact configuration of the grooves, where h=distance between the pendulum and the capacitive pick-off plate 28, and d=depth of groove, that is the effect of a groove. Thus, the value of the damping coefficient is well approximated by 1/h³ when d is small compared to h.

When the depth d of the grooves formed in the pendulum is significant compared with the distance h, the present invention significantly affects the assumption that damping is described by theoretical flat plate damping. For example, when the pendulum is positioned near one of the two capacitive pick-off plates 28, i.e., when the accelerometer is no longer in servo but is operating beyond its design range, such that h≈d, damping can be thought of as arising from two types of regions: one for the flat plate region where the coefficient varies as 1/h³, and one for the groove region where the coefficient varies as 1/(h+d)³. Thus, when significant grooves are formed in the pendulum, the result is a composite coefficient of damping which varies with an intermediate behavior. The exact details of the damping depend on the groove configuration, which determines the interaction between the airflows between the two types of regions, the flat plate area and the grooved area.

When the depth d of grooves formed in the pendulum is small compared with the distance h, the grooves do not significantly affect the component of damping due to frictional gas flow across the pendulum surface. For example, when the pendulum is positioned equidistant from each of the two capacitive pick-off plates 28, i.e., when the accelerometer is in servo, grooves which are smaller in depth than the distance separating the pendulum and the capacitive pick-off plates 28 do not significantly affect the restriction to flow of gas trapped between the pendulum and the capacitive pick-off plates 28.

When the depth d of grooves formed in the pendulum is significant compared with the distance h, the grooves significantly affect the component of damping due to frictional gas flow across the pendulum surface by reducing the restriction to gas flow. For example, when the pendulum is positioned near one of the two capacitive pick-off plates 28, i.e., when the accelerometer is no longer in servo but is operating beyond its design range, a groove having a depth d equivalent to or greater than the reduced distance h provides a path for gas trapped between the pendulum and the capacitive pick-off plate 28 to escape. Thus, the grooves contribute to a reduction in the component of damping due to frictional gas flow across the pendulum surface.

When the depth d of grooves formed in the pendulum is significant compared with the distance h, the grooves significantly affect the component of damping due to frictional gas flow across the pendulum surface by reducing the restriction to gas flow. For example, when the pendulum is positioned near one of the two capacitive pick-off plates 28, i.e., when the accelerometer is in no longer in servo but is operating beyond its design range, a groove having a depth d equivalent to or greater than the reduced distance h provides a path for gas trapped between the pendulum and the capacitive pick-off plate 28 to escape. Thus, the grooves contribute to a reduction in the component of damping due to frictional gas flow across the pendulum surface.

When the depth d of grooves formed in the pendulum is significant compared with the distance h, the grooves significantly affect the component of damping due to frictional gas flow across the pendulum surface. For example, when the pendulum is positioned equidistant between the two capacitive pick-off plates 28, i.e., when the accelerometer is in servo, a groove having a depth d equivalent to the dimension h provides a significant path for trapped gas to escape and flow across the pendulum surface, which effectively reduces the component of damping due to frictional gas flow.

When holes or passages are formed in the pendulum, either alone or in combination with grooves, the holes significantly affect the flat plate damping coefficient. For example, if a series of holes changes the effective damping area from a square area A to n smaller area squares, each smaller-area square having an area A/n, then the quadratic dependence of damping on area reduces the damping to n*(A/n)²=A²/n.

When holes or passages are formed in the pendulum, either alone or in combination with grooves, the holes significantly affect the component of damping due to frictional gas flow across the pendulum surface. For example, when the pendulum is positioned equidistant between the two capacitive pick-off plates 28, i.e., when the accelerometer is in servo, one or more holes remove a significant area of the pendulum surface, thereby providing a significant path for trapped gas to escape without flowing across the pendulum surface, which effectively reduces the damping due to frictional gas flow.

The typical spacing between the pendulum and the capacitive pick-off plate 28 in a capacitive pick-off accelerometer is on the order of 0.000750 inches. The spacing dimension is driven by the capacitive nature of the device; the need to provide gas damping; and manufacturing tolerances inherent in the processes employed.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A force-rebalance accelerometer comprising:
a first and a second stator member wherein each of said stator members includes a generally planar capacitive pick-off area;
a proof mass assembly rotatably secured between said first and said second stator members by at least one flexure member wherein said proof mass includes an arcuate reed member having an upper surface and a lower surface;
at least one capacitive pick-off area deposited on at least one surface of said reed member;
a gap formed between said capacitive pick-off area of at least one of said stator members and at least one surface of said reed member; and
a plurality of ventilation grooves configured on at least one surface of said reed member, said grooves having a depth less than said gap and whereby said grooves are sized such that a coefficient of damping of said proof mass assembly exhibits substantially reduced non-linearity as a function of a proof mass assembly position relative to said first and second stator members.

2. The accelerometer of claim 1, wherein said reed member includes a central cut out portion and said grooves consist of a radial groove, said radial groove extending from said central cut out portion to the edge of said reed member.

3. The accelerometer of claim 1, wherein said grooves have an approximate depth of 0.0005 inches.

4. The accelerometer of claim 1, wherein said grooves have a width of approximately 0.020 inches.

5. A force-rebalance accelerometer comprising:
a first and a second stator member wherein each of said stator members includes a generally planar capacitive pick-off area;
a proof mass assembly rotatably secured between said first and said second stator members by at least one flexure member wherein said proof mass includes an arcuate reed member having an upper and a lower surface;
at least one capacitive pick-off area deposited on at least one surface of said reed member;
a first gap formed between said capacitive pick-off area of said first stator member and said upper surface of said reed member;
a second gap formed between said capacitive pick-off area of said second stator member and said lower surface of said reed member; and
a plurality of radial ventilation grooves configured on at least one of said upper and lower surfaces of said reed member, said grooves having a depth less than said first and second gaps and whereby said grooves are sized such that a coefficient of damping of said proof mass assembly exhibits substantially reduced non-linearity as a function of a proof mass assembly position relative to said first and second stator members.

6. The accelerometer of claim 5, wherein said grooves are located on both said upper surface and said lower surface of said reed.

7. The accelerometer of claim 6, further comprising at least five of said grooves located on both said upper and lower surfaces of said reed.

8. The accelerometer of claim 7, wherein said grooves extend to the edge of said reed member.

11. A force-rebalance accelerometer comprising:
a first and a second stator member wherein each of said stator members includes a generally planar capacitive pick-off area;
a proof mass assembly rotatably secured between said first and said second stator members by at least one flexure member wherein said proof mass includes an arcuate reed member having an upper surface and a lower surface;
at least one capacitive pick-off area deposited on at least one surface of said reed member;
a gap formed between said capacitive pick-off area of at least one said stator members and at least one surface of said reed member; and
a plurality of ventilation grooves configured on at least one surface of said reed member, wherein said grooves have an approximate depth of 0.0005 inches and whereby said grooves are sized such that a coefficient of damping of said proof mass assembly exhibits substantially reduced non-linearity as a function of a proof mass assembly position relative to said first and second stator members.

12. The accelerometer of claim 11, wherein said reed member includes a central cut out portion and said grooves consist of a radial groove, said radial groove extending from said central cut out portion to the edge of said reed member.

14. The accelerometer of claim 11, wherein said grooves have a width of approximately 0.020 inches.

15. A force-rebalance accelerometer comprising:
a first and second stator member wherein each of said stator members includes a generally planar capacitive pick-off area;
a proof mass assembly rotatably secured between said first and said second stator members by at least one flexure member wherein said proof mass includes an arcuate reed member having an upper and a lower surface;
at least one capacitive pick-off area deposited on at least one surface of said reed member;
a first gap formed between said capacitive pick-off area of said first stator member and said upper surface of said reed member;
a second gap formed between said capacitive pick-off area of said second stator member and said lower surface of said reed member; and
a plurality of radial ventilation grooves configured on at least one of said upper and lower surfaces of said reed member, wherein said grooves have an approximate depth of 0.0005 inches and whereby said grooves are sized such that a coefficient of damping of said proof mass assembly exhibits substantially reduced non-linearity as a function of a proof mass assembly position relative to said first and second stator members.

16. The accelerometer of claim 15, wherein said grooves are located on both said upper surface and said lower surface of the reed.

17. The accelerometer of claim 16, further comprising at least five of said grooves located on both said upper and lower surfaces of said reed.

18. The accelerometer of claim 17, wherein said grooves extend to the edge of said reed member.
